(19) United States
(12) Patent Application Publication
(10) Pub. No.: US 2005/0060286 A1
(43) Pub. Date: Mar. 17, 2005

(54) Free text search within a relational database

(75) Inventors: Jesper Theil Hansen, Taastrup (DK); Michael Fruergaard Pontoppidan, Lynge (DK)

Correspondence Address: Nathan M. Rau;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/663,341

(22) Filed: Sep. 15, 2003

(51) Int. Cl. G06F 17/30

(52) U.S. Cl. 707/2

(57) ABSTRACT

Disclosed is a crawler and search engine for a business data database. The crawler is configured to intermittently access data in the business data database and index the data to an index database. The crawler is also configured to monitor the load on the database and to adjust it's crawl rate in response to the load. The search engine searches through the index database in response to user queries. Results from the query are displayed to the user and when selected take the user to the associate record in the business data database.

### BACKGROUND OF THE INVENTION

The present invention relates to searching and indexing business data that is stored in a business data database. In particular, the present invention relates to an indexing tool and a search tool used in a business application server.

Computer networks connect large numbers of computers together so that they many share data and applications with one another. Examples include Intranets that connect computers within a corporation and a global computer network, such as the Internet, which connects computers throughout the world.

A single computer can be connected to both an Intranet and the Internet. In such a configuration, the computer can access data and applications on its own storage media or it can access data and applications located on another computer connected to either the Intranet or Internet. One example of an application is a business application server, which allows a company to manage various functions of the business (human resources, warehouse management, accounting, etc.) on one application through the use of modules. The data used to drive the modules is stored in a database.

Typically, in the past, users of business applications software have limited access to their databases to those solely within their own Intranet, and sometimes only to a single machine. However, as businesses have moved to an on-line-real-time environment it has become important to share portions of the information contained in the database with vendors, suppliers, or customers.

As businesses have made their databases available to persons outside the home organization through various interfaces including the worldwide web, there has been a desire by both the businesses and the outside organizations to rapidly find information stored in the database. However, databases associated with business application servers are generally large and complex, and do not lend themselves easily to locating the desired data. Further, users have become accustomed to using search engines, including full text searching available from Internet search engines, to quickly find information on the Internet. Thus, users of business application servers have desired the ability to search for data across the entire database using similar full text features of Internet searching.

Traditionally, business applications have executed real time searches in limited sections of the huge amounts of data stored in the business application's relational database. However, when real time searching is expanded across all data in the database, a large load is placed on the backend server and the database system. The backend server and database system are also used at the same time for strategic business systems. Therefore, there has been a desire by users of business application servers for a system that employs full text searching across an entire relational database without sacrificing performance of the system on critical daily activities.

### SUMMARY OF THE INVENTION

The present invention addresses some of the problems that have been observed when searching a business data database containing business data by limiting the affect of the searching process on the performance of the business data database system.

The present invention can be implemented with a wide variety of features. One embodiment of the present invention is directed to a method of indexing data in a business data database. Implementation of the indexing process is executed through a crawler, or other module, that moves methodically through the business data database reading and indexing each record in the database. The crawler is able to run as a daemon on the backend system that supports the business data database. Daemons are processes that are run in the background attending to various tasks without the need for human intervention.

A user or administrator sets the crawler in action by opening a user interface window. In this window the administrator can select the fields of the database to be indexed. The selection of the fields allows the administrator to control what information contained in the database can be searched by users of the search engine. Also in the user interface the administrator of the crawler can set the speed at which the crawler will index records in the database. The ability to set the speed of the crawler helps reduce the overall effect of the crawler on the database system. This addresses problems which have arisen in the past, in that real time searches on the database system have resulted in a large load placed on the system, which has caused a significant reduction in the overall performance of the crawler.

As the crawler is activated it proceeds through each record in the business data database one record at a time. The crawler indexes the identified records by copying the fields and data to the index table. In one embodiment, the crawler indexes the records as a text entry in the index table. During the indexing process the speed control module monitors the load on the business data database to insure that the crawler is not adversely affecting the performance of other programs running on the backend system. If the crawler is affecting the backend system, the speed control module adjusts the crawler's speed through the business data database to eliminate the adverse affects on system performance.

The crawler proceeds through the database until instructed to stop crawling. When the crawler reaches the last record in the business data database it returns to the first entry in the database and proceeds to re-index the records. In another embodiment, the crawler on the second and subsequent crawls through the database only re-indexes records that have been updated since the last crawl.

Another embodiment of the present invention is directed to a search engine for a business data database. The search engine receives a user query, and identifies entries in the index table that match the query terms. The identified results are ranked by the search engine, and then compared against the user's permission. If the user does not have permission to view a specific record in the results, then that record is removed from the list of results. The remaining results are returned to the user. The user then selects the desired result from the presented results. The selected result is then displayed to the user, either from the index table or from the record in the business data database.

### BRIEF DESCRIPTION OF THE DRAWINGS

FIG. 1 is a block diagram of one exemplary environment in which the present invention can be used.

FIG. 2 is a block diagram illustrating the components of the free text search system of the present invention.

FIGS. 3A and 3B are a flow diagram illustrating the steps executed by the crawler when indexing the data in the business data database.

FIG. 4 is an example of a user interface for controlling and setting functions of the crawler.

FIG. 5 is a flow diagram illustrating the steps executed by the search engine when the user desires to search the business data database.

FIG. 6 is an example of a user interface invoked by the user when searching the business data database.

### DETAILED DESCRIPTION OF ILLUSTRATIVE EMBODIMENTS

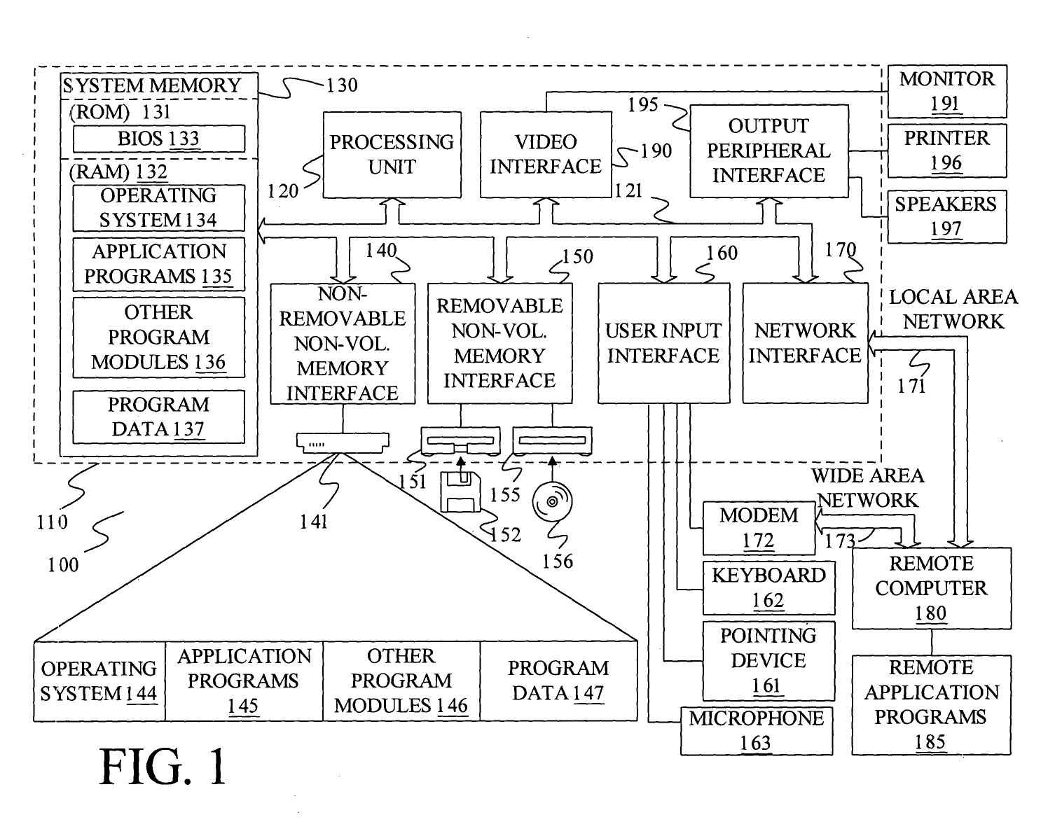

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

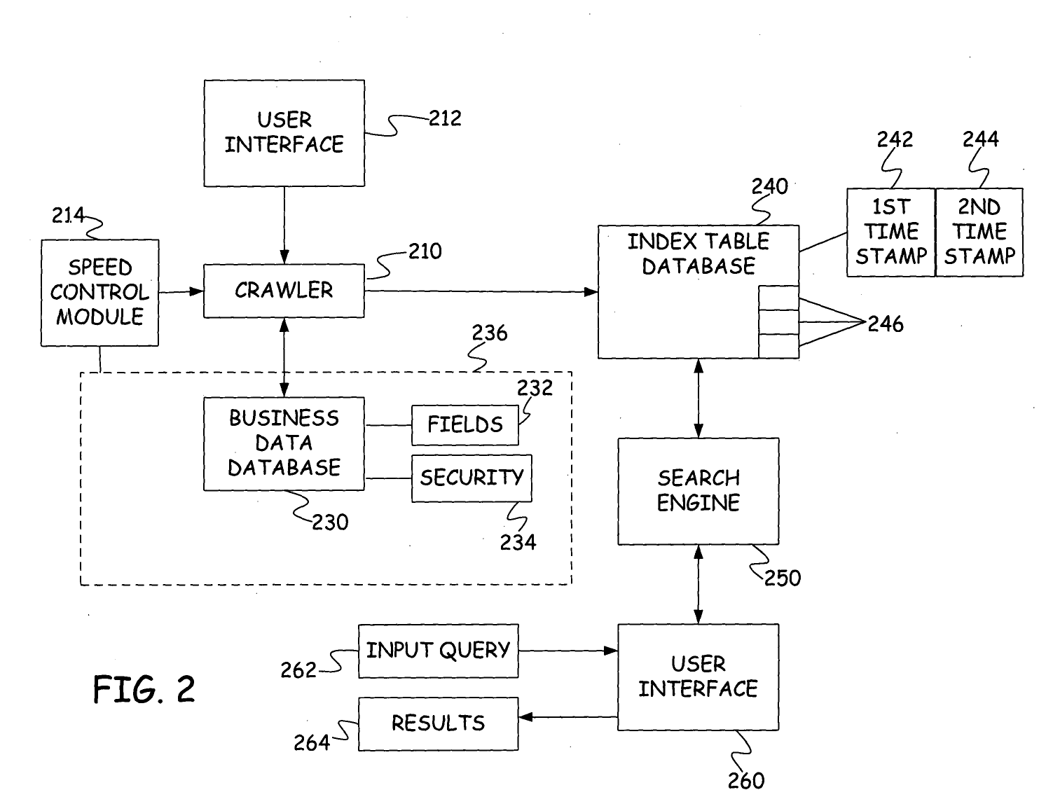

FIG. 2 is a block diagram illustrating the components as well as the relationship between the components of a free text search system 200 according to one embodiment of the present invention. The free text search system 200 can, in one embodiment, operate on a computer system similar to the computer system 100 described in FIG. 1 above. However, in other embodiments free text search system 200 can operate on multiple computer systems 100, or across a network of interconnected computers. The free text search system 200 includes a crawler 210, a search engine 250, a business entity data table or business atabase 230, and an index table 240.

Crawler 210 is a computer program that is configured to intermittently access and retrieve data contained in the business data database 230. Crawler 210 “crawls” through the data by running as a daemon in a separate thread on the backend server.

Business data database 230 contains information related to the business such as business entities, and is located on a business data database system 236 operating on a backend server (not illustrated separately). Business data database 230 contains a plurality of fields 232 related to each entity or record in the business data database 230. The plurality of fields can include fields such as customer, inventory, record ID, address, phone number, etc. Further, business data database 230 can include a time stamp indicating when the record in the business data database 230 was created or last edited. However, those skilled in the art will appreciate that other fields 232 than those enumerated above can be present in the business data database 230.

Linked to each field 232 in database 230 is an associated entry containing data related to the specific entry in the database 230. Further, each entry or field 232 in database 230 can include a metadata security store 234. Metadata security store 234 is an additional metadata field for each record or entry that is used to protect the security of the data contained in database 230. This field prevents unauthorized persons or entities from viewing the contents or specific portions of the entry in database 230. However, other security methods can be implemented to protect the integrity of the database 230.

Crawler 210 is also connected to a user interface 212. In one embodiment, user interface 212 generates a display window on a computer screen that allows an administrator or other user to define the parameters that are used by the crawler 210 to crawl through the database 230. However, other interfaces can be used. In this embodiment, the user interface 212 is configured with a series of pull down menus that allow the administrator to view a list of all metadata fields 232 present in the business data database 230. The administrator then can select a single field or a plurality of metadata fields. The selected fields are the fields 232 the crawler 210 will index during a crawl. In some embodiments of the present invention the user interface 212 includes an area to determine the rate at which the crawler 210 will advance through the business data database 230. The rate at which the crawler 210 crawls through the database 230 is controlled by the speed control module 214.

Speed control module 214 is a computer program configured to regulate the rate at which the crawler 210 crawls through the database 230. Through the speed control module 214 it is possible to set the crawl speed such that crawler 210 minimizes it's impact on the operation of modules running on the business application server using the business data database 230. The administrator can select the time between accessing each record (or pause time) in at least two ways. First, the administrator can select, by typing in the exact time to wait before accessing the next record in the business data database 230, i.e. 0.01 seconds between each record. Second, the administrator can select in the user interface 212 one of a set of predetermined crawl speeds. For example, the administrator could choose from slow, medium, fast, and faster, where each speed represents a different predetermined pause time before accessing the next record in the database 230. However, other methods can be used to set the pause time, such as using a sliding wiper to adjust the crawl speed from one speed to another.

As the crawler 210 accesses records in the business data database 230 it uses a portion of the resources available to other business applications on the backend server. If a user's search is carried out directly on the database 230 in real time, an enormous load is placed on both the backend server and the business data database system 236. This large load can result in the inability of users of the business data database 230 to access needed data in a reasonable amount of time. Further, even the accessing of the business data database 230 by the crawler 210 has the potential to slow the database system and the backend server 236 down to a point that users notice an increase in latency or access time. Therefore, in another embodiment, speed control module 214 is configured to minimize the effect on the database system 236 caused by the crawler 210.

To achieve this desired result, speed control module 214 is, in one embodiment, configured to monitor the load on the database system 236. The speed control module 214 compares the monitored load with at least one predetermined threshold. One threshold value represents a load where further accessing of data in the business data database 230 at the current rate would affect the performance of database system 236. This threshold value can change as the speed of the crawler 210 changes or as another program/user accesses the database 230. If the load on the database system exceeds the threshold value, the speed control module 214 is configured to adjust the speed of the crawler 210 to bring the load on the system below the threshold value. To achieve this, the speed control module 214 slows the crawl rate of the crawler 210. This reduction can optionally occur despite a different rate setting by the administrator. After a predetermined period of time has passed at the lower crawl rate the speed control module 214 can increase the rate of crawl back to the original rate.

In another embodiment, the speed control module 214 compares the current load on the database system 236 with a second threshold value. This second threshold value represents a load value where the crawler 210 can increase its rate of crawl through the database 230 without creating a negative affect on the overall performance of the database system 236. If the load is below the second threshold, which illustratively can occur at night when there are generally far less users on the database system, the speed control module 214 can increase the rate of crawl through the database 230. This increased rate of crawl can optionally exceed the preselected rate set by the administrator. This second threshold value can also be used when returning the crawler back to the predetermined speed.

Based on the selected metadata fields 232 the crawler 210 crawls through the business data database 230. When the crawler reaches an entry in the database 230, it copies the unique identifier and associated data to the index table 240, and an associated time stamp for the record. The index table 240 is a database that is populated by the crawler 210 with selected data from business data database 230. Index table 240 can include a field indicating the last two index times through the database 230 by the crawler 210. This field is particularly useful when the crawler 210 is somewhat intelligent. However, in an alternative embodiment, a single time stamp indicating the indexing time of the crawl can be used. In yet another embodiment, the crawler includes a time stamp field indicating the time each record in the index table was created. In this embodiment any comparisons to the time stamp compares the time stamp for the record when it was indexed to other time stamps.

The data stored in the index table 240 is stored as a textual representation of all of the metadata fields 232 selected in each record. Each field of the index table 240 is separated by a delineator (i.e. “,” or comma delineated) such that each metadata field and data are clearly identified, and do not overlap with another field. However, other types of data storage and delineation can be used.

Each record in the index table 240 is indexed with a record locator of the associated record in the business data database 230. This is done so that when records are updated in later crawls the original record in the database 230 can be found with minimal additional processing. For example, this eliminates the need to research for a record, or makes it easy to tell if the record has been deleted from the business data database 230. However, a unique or globally unique identifier can be used to identify each of the records in index table 240.

Search engine 250 is configured to search the index table 240 in response to a user query 262. The user query 262 is input to the search engine 250 via a user interface 260. In one embodiment, user interface 260 is a web browser, such as Internet Explorer by Microsoft Corporation of Redmond, Wash. However, other user interfaces 260 can be used. User interface 260 presents to a user an interface where the user can enter the query 262 as a textual query. The user can formulate the query 262 as a typical Internet style search. However, in other embodiments the user can speak the desired query 262, which is then transferred into a textual representation using known speech to text methods. The query 262 is then passed from the user interface 260 to the search engine.

The search engine 250, upon receiving the query 262, accesses the index table 240 and initiates a string comparison. The search engine 250 looks up each word in the input query 262, and identifies a number of records 246 in the index table 240 that match each word of the query 262. Then the search engine 250 identifies a number of records 246 in the index table 240 that have a combination of the words in the query 262. In one embodiment, the matches are scored on a numerical basis, where each occurrence of a single word in the query 262 is scored 1 point and each occurrence of multiple words in the query 262 is scored 100 points. However, other values, or methods of scoring or ranking the results 264 can be used. Other methods of comparing the search query with database terms can include natural language processing on the input query and the index. Further, comparisons can be made by generating logical terms for both the input query and the indexed records. The results 264 are then returned to the user interface 260 to be displayed to the user.

In one embodiment, the results 264 are checked gainst the user's permissions to ensure that the ser is allowed access to the data found during the search. As the index table 240 and search engine 250 may be available to users outside the “home system”, this check insures that confidential data is not released to those without authorization to view the data.

Prior to submitting the query 262 to the search engine 250, the user interface 260 can challenge the user to provide their credentials or permissions. These credentials verify the data the user is permitted to access and view. The user can provide these credentials by logging into the system with a password, by using Internet cookies, by accessing the system 200 from an approved portal, or any other method of verifying who the user is. Based on the permissions granted to the user, the user interface 260 or search engine 250 then filters the results 264 of the search, by removing any returns that exceeds the user's permissions.

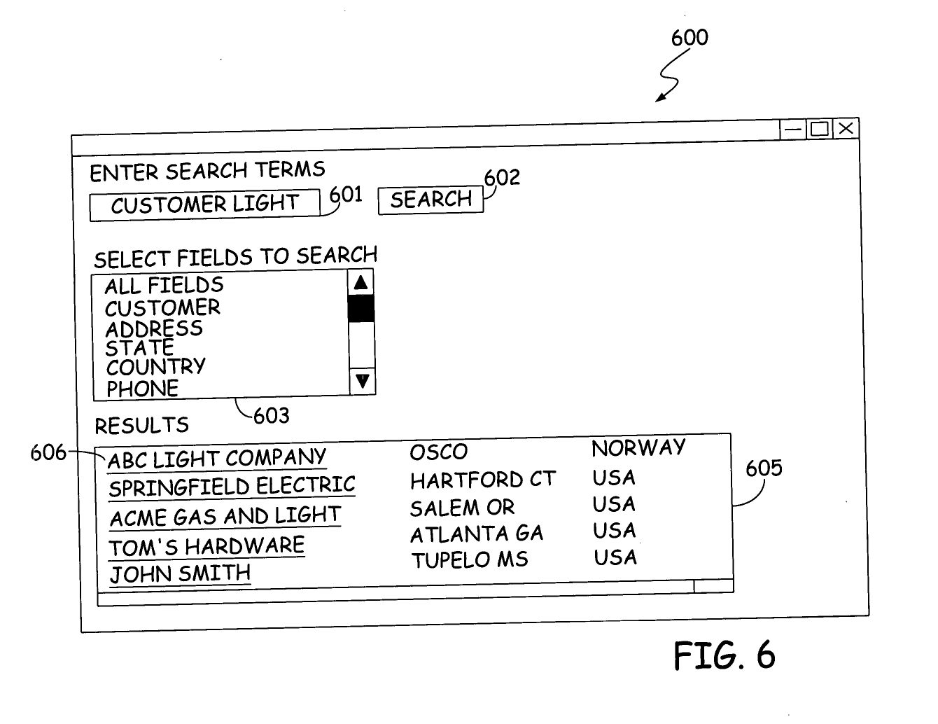

The results 264 are displayed to the user via the user interface 260. The user interface can display the results 264 in a variety of different ways depending on the type of business data contained in the business data database 230 or the preferences of the business. In one embodiment, both the input query 262 and the results 264 are displayed in a web browser. The results 264 are presented to the user in a top down format, i.e. the results believed to best match the query 262 are presented first. The results can be presented as links to the data in the business data database 230 through hyper-text-mark-up (HTML) language and a URL link. When presented in HTML the user merely clicks on the result that they want. The user interface 260 then presents to the user all of the data for the selected record contained in the index table 240. Alternatively, the link can access the associated record in the business data database 230. An example of the return screen and results is illustrated in FIG. 6. However, other methods of returning the results to the user can be used.

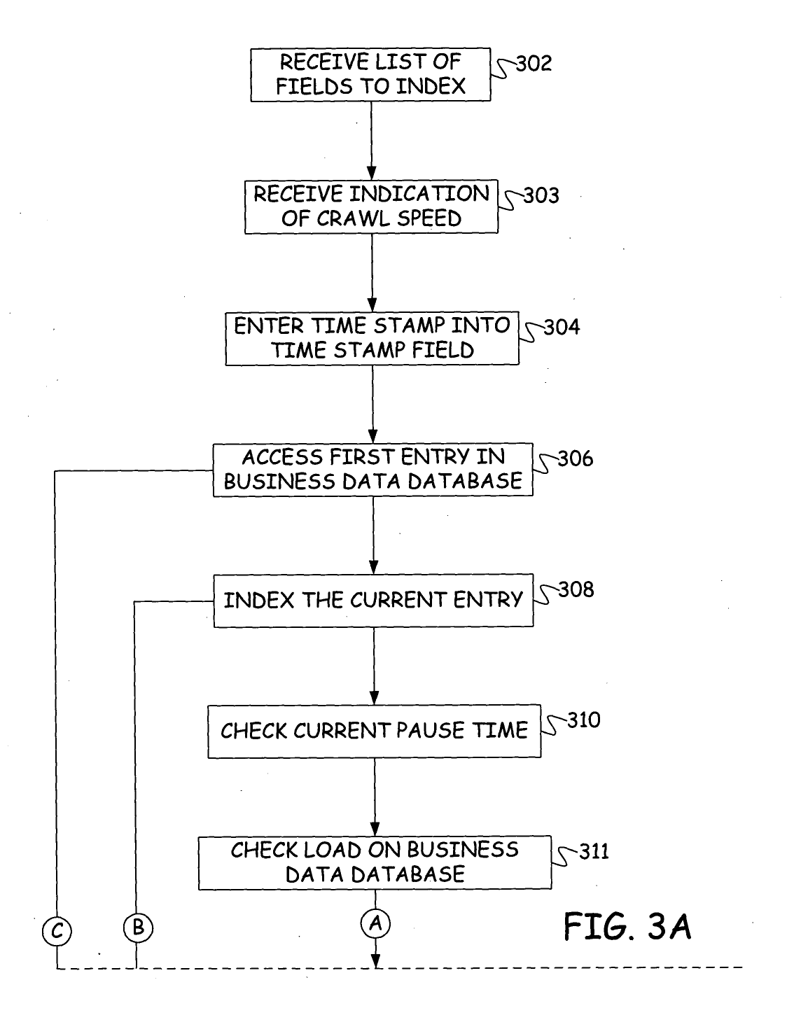

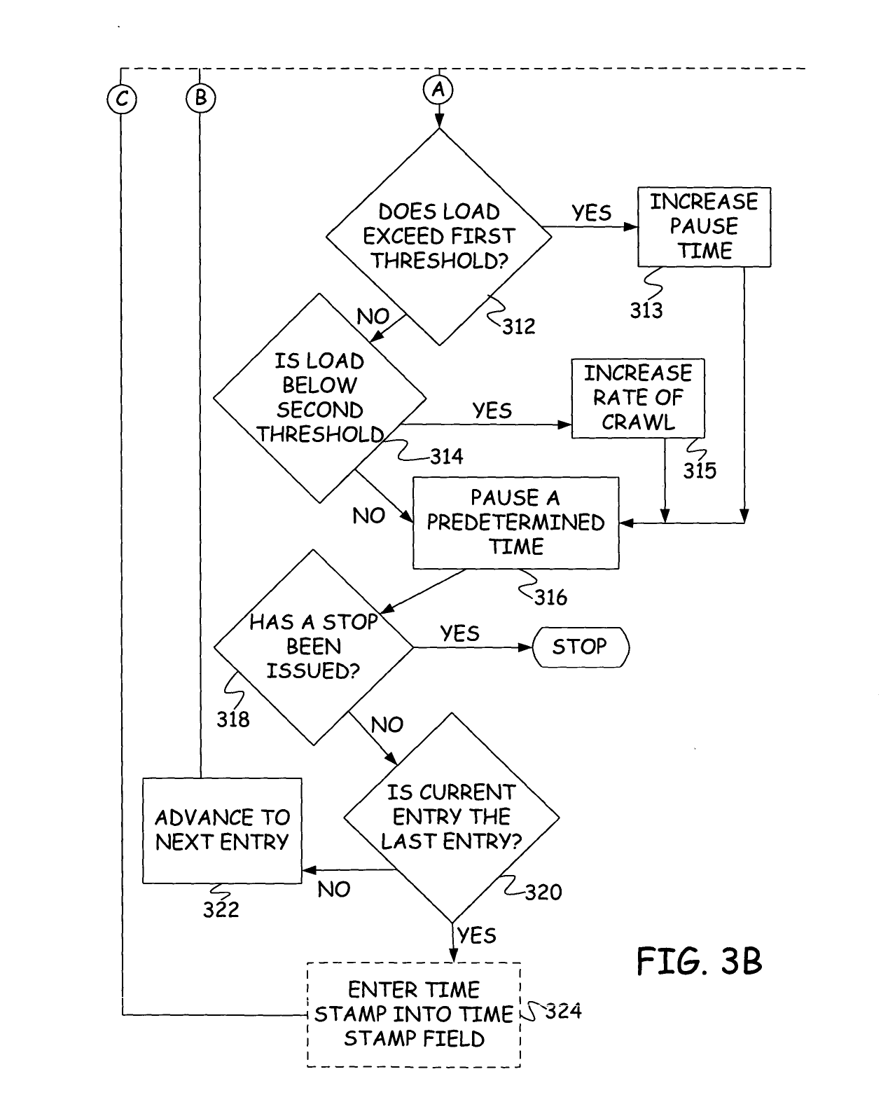

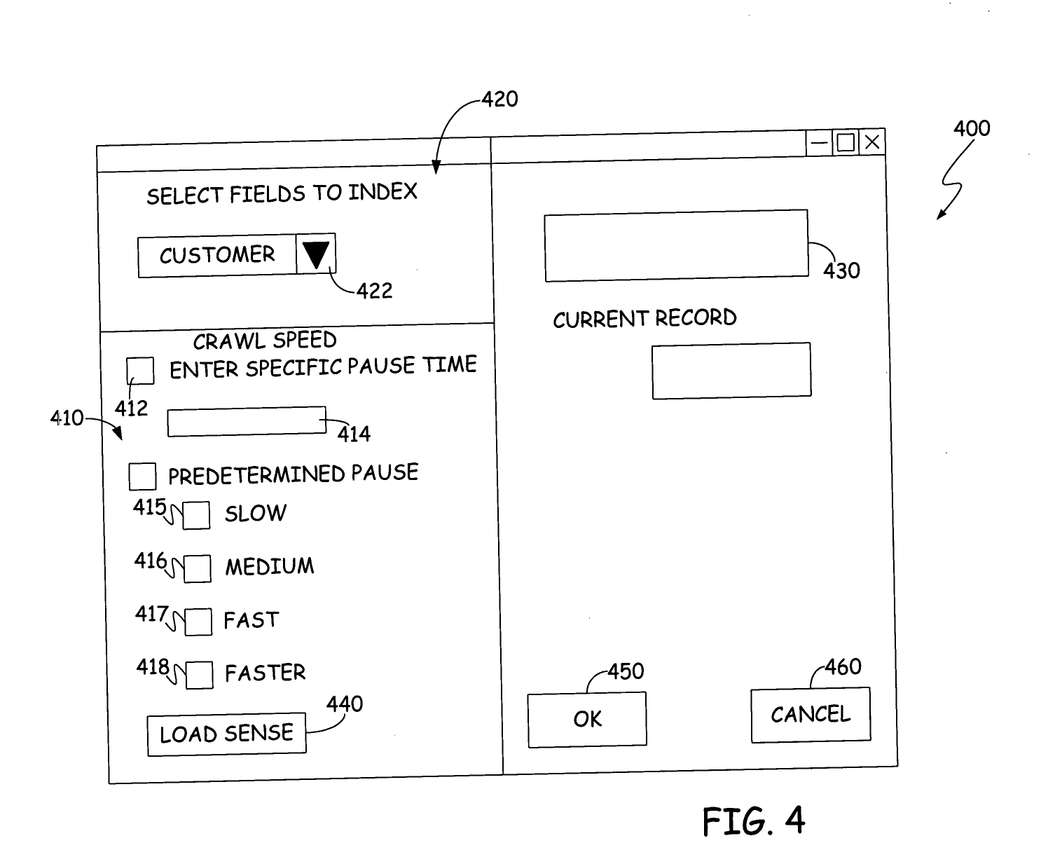

FIGS. 3A & 3B, taken together, are a flow diagram illustrating the steps performed by the crawler component 210 in FIG. 2 when indexing the data in the business data database 230. FIGS. 3A & 3B are best understood when joined together along dashed line 301 that appears in both FIGS. 3A and 3B. Lines of flow that extend between FIGS. 3A & 3B are further identified by transfer bubbles A, B, & C which appear in both FIGS. 3A & 3B. In order to start the crawler 210 the administrator opens user interface 220. One example of user interface 220 is illustrated in FIG. 4.

FIG. 4 illustrates one possible user interface 400 that can be presented to the user. User interface 400 includes a crawl speed selector 410, an index field selector 420, and a progress bar 430. In the index field selector 420 is a pull down/scroll bar listing all of the fields in the business data database 230. The user can select the field or fields to be indexed by highlighting the appropriate field names in the index field selector 420. If the number of fields in the index field selector 420 cannot be displayed the user can access the additional fields through the use of spinner keys 422. Alternatively, the fields to be indexed can be indicated by selecting a check box next to the fields. Other methods of selecting the fields to be indexed can also be used.

Next, the user selects in the user interface 400 a desired rate of crawl through the business data database 230. In the embodiment illustrated in FIG. 4, the user can select from four different predetermined rates of crawl in area 410. These rates of crawl are slow, medium, fast and faster and indicated by reference numbers 415, 416, 417 and 418 respectively. The user can also choose a customized rate of crawl by selecting box 412, and inputting a desired pause time in box 414 that represents the time the crawler 210 will pause between finishing the indexing of a current record and accessing the next record in the business data database 230. Also illustrated in FIG. 4 is a button 440 that allows the user to determine if the crawler 210 will use it's load sensitivity function to automatically adjust the crawler's speed in response to the load currently experienced by the business data database 230.

When the user clicks the “ok” button 450 in the user interface 400, the user interface 400 transmits to the crawler 230 a list of fields to be indexed, and a desired rate of advance through the business data database 230. The receipt of the metadata fields to be indexed is illustrated by step 302 in FIG. 3. The receipt of these two features starts the crawler 210 accessing, and retrieving the information stored in the fields of business data database 230. The progress of the crawler can be viewed through the progress bar 430 of the user interface 400.

Once the crawler 230 is activated by the user it will crawl through the business data database 230 until a stop signal is received. In one embodiment, on the first indexing of the business data database 230 the crawler 210 accessed the index table 240, and places in a first time stamp field 242 the time stamp for the first pass through the business data database 230. This is illustrated at block 304 of FIG. 3. During this pass, the entry for the second time stamp field 244 is empty. However, depending on how the crawler 210 is programmed, this time stamp can be placed in the field 244 for the second time stamp, and the first time stamp field 242 would remain empty. Other implementations of the time stamp can be used such as a single time stamp indicationg the index time of the current crawl, a time stamp for each record indicating when the record was indexed, or any other number of time stamps (3, 4, 5 etc).

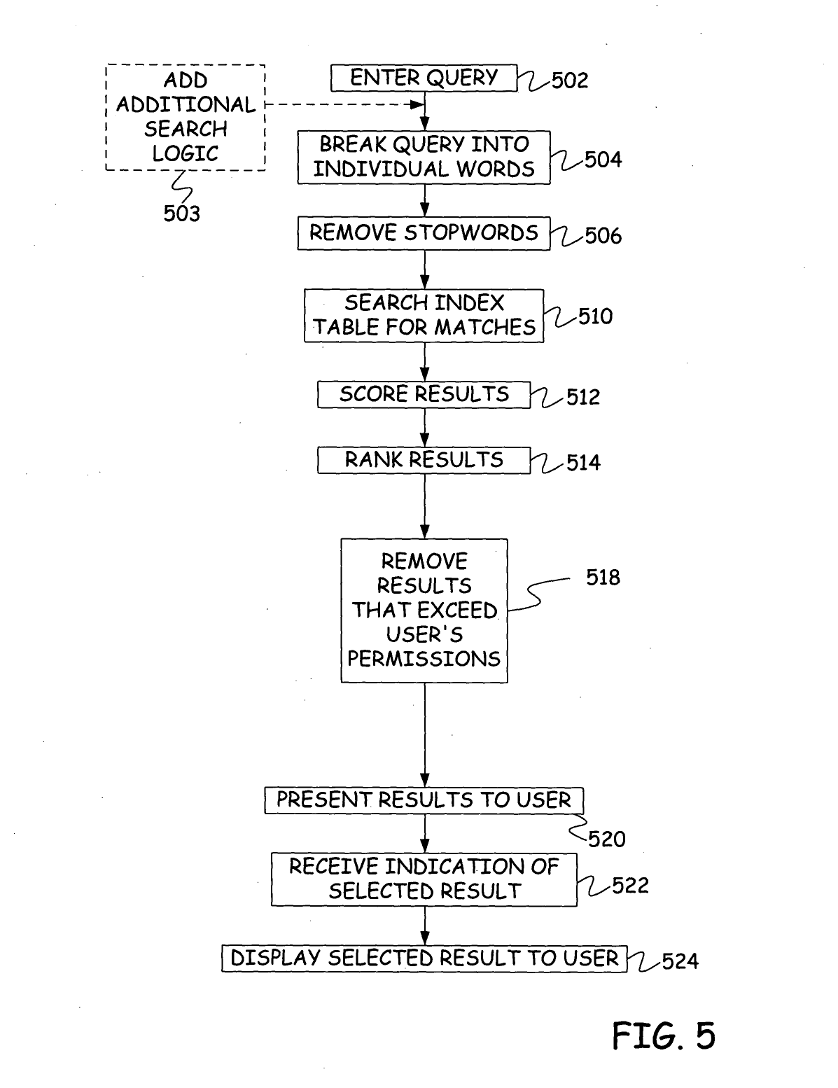

Next, the crawler 210 accesses the first record or entry in the business data database 230. This is illustrated by block 306 in FIG. 3. Once the record has been accessed the crawler 210 then indexes the fields and data in the fields selected through the user interface 400 at step 302 above. In one embodiment, where the business data database 230 is a structured query language (SQL) database including metadata tags indicating the fields, the crawler 210 first identifies those fields in the record. Then the crawler copies each field and it's associated data to the index table 240. Each record in the index table 240 is assigned the same key or record locator identifier as the record has in the business data database 230. This helps improve the efficiency of the search engine 250, as it does not have to research for the record in the business data database 230 when the record is chosen as a match to the search. The search process will be discussed in greater detail with reference to FIG. 5.

The metadata fields and associated data are converted to a text string using a known technique. Each field and data is separated by a delineator such as a comma or a set number of spaces. This helps to ensure that unrelated data fields are not confused during a search, as well as allowing the presentation of the correct data and fields to the user following a search. However, other methods of indexing the records can be used. The indexing of the entry is illustrated by block 308 in FIG. 3.

Following accessing the record in the business data database 230, the crawler 210 waits or pauses a predetermined amount of time prior to advancing and accessing the next record in the business data database 230. The length of the pause is determined by the speed control module 214, and the selected rate from the user interface 400. This checking of the pause rate is illustrated by block 310 in FIG. 3.

During this pausing period the speed control module 214 of the crawler component 210 checks the load on the business data database 230. The load check is illustrated at block 311. This load check is done to ensure that access to the business data database 230 by users is not affected by the crawler 210. As the crawler 210 uses resources of the business data database 230 when it accesses records it reduces the performance of the business data database system 236. If the number of users or accesses to the business data database 230 is high, the potential exists for the business data database system 236 to bog down or even crash. To prevent the crawler 210 from negatively affecting the performance of the business data database system 236, a check is made against a first threshold value. This first threshold value represents a load at which the crawler 210 can negatively affect the business data database system when the crawler 210 is operating at it's current rate. As discussed above, the first threshold value can be a constant value or it can vary depending on the current load of the business data database 230. This check against the first threshold value is illustrated by block 312 in FIG. 3.

If the load on the business data database system 236 exceeded the first threshold value, the speed control module 214 increases the pause time of the crawler 210 between records, i.e. reduces the rate of crawl. This is illustrated at block 313 in FIG. 3. The amount by which the speed control module 214 reduces the rate of crawl can be determined several ways. In one embodiment, the rate of crawl is reduced by a fixed percentage, i.e. 25%. In another embodiment, the rate of crawl is reduced to the next slowest pre-programmed level i.e. from fast to medium. However, other methods and amounts can be used to reduce the rate of crawl. If the load exceeds the first threshold level by predetermined amount, i.e. 100% then the speed controller 214 can stop the crawler until the load on the business data database system 236 returns to an acceptable level. If the controller 214 stopped the crawler, a message or other indication can be presented to the user via user interface 400. Otherwise the only indication to the user of the stop or hold would be by observing the progress bar 430.

If the load on the business data database system 236 did not exceed the first threshold value, the speed control module 214 then compares the current load against a second threshold value. This is illustrated at block 314 of FIG. 3. The second threshold value represents a load on the business data database system 236 where the crawler 210 can increase it's rate of crawl without negatively affecting the business data database system 236. If the load on the business data database system 236 is less than the second threshold value the speed control module 214 increases the rate of crawl through the business data database 230. In one embodiment, the speed control module 214 increases the rate of crawl by a predetermined amount i.e. 25% or to the next fastest preprogrammed rate of crawl i.e. from medium to fast. However, other increase values can be selected. This is illustrated at block 315.

Regardless of whether the rate of crawl was changed, the crawler 210 pauses for a predetermined amount of time. This pausing is illustrated at block 316 of FIG. 3. However, prior to advancing to the next record/entry in the business data database 230, two additional operations are performed. First, the crawler 210 checks to see if a stop command has been received from the user. This is illustrated at block 318 of FIG. 3. The stop command can in one embodiment be executed by clicking on “cancel” button 460 in user interface 400. However, other methods can be used to stop crawler 210. Second, the crawler 210 checks to see if the current entry is the last entry in the business data database 230. This is illustrated at block 320 of FIG. 3.

If the entry was not the last entry in the business data database 230, the crawler 210 advances to the next entry in the business data database 230. This is illustrated at block 322 of FIG. 3. Following the advancing to the next entry, the crawler 210 returns to block 308 and indexes the new record and repeats the indexing process over again.

If the entry was the last entry in the business data database 230 a number of different functions are optionally executed. First, the crawler 210 enters the current time stamp into the second time stamp field 244 of the index table 240. This is illustrated in phantom at block 324 of FIG. 3. However, if the second time stamp field is currently filed with a time stamp, the crawler 210 then moves this time stamp to the first time stamp field 242. By moving the second time stamp field entry to the first time stamp field 242 the oldest time stamp in the index table 240 is overwritten. However, other methods of merging and entry of the time stamps can be used. For example, if only one time stamp is used the time stamp indicating the start time of the last indexing of the business data database 230 is replaced with the current time stamp of the start of the second or subsequent indexing. Also in other embodiments the replacement of the time stamp can be done for each record in the index table 240 as the record is indexed. Next, the crawler returns to block 306 by accessing the first entry in the business data database 230.

When the crawler 210 indexes the entry at block 308 an additional process can occur. This process is only executed once the business data database 230 has been indexed. Prior to indexing the entry, the crawler 210 compares a date modified field of the entry in the business data database 230 with the time stamp in the first time stamp field 242. If the date modified is after the time stamp 242 the record is reindexed at block 308 to incorporate any updates that occurred to the record. However, if the date modified is earlier than the time stamp, the crawler 210 need not reindex the record as no changes have been made since the record was last indexed. If so programmed, the crawler 210 will proceed to block 312 and continue the process illustrated in FIG. 3. This comparison of time stamp to date field will occur as long as there is a time stamp entry in both time stamp fields 242 and 244. However, in other embodiments the comparison can occur if only one time stamp is present, or if the record in the index table contains a time stamp then this comparison occurs for every record.

FIG. 5 is a flow diagram illustrating the steps executed by the search engine 250 of FIG. 2 when a search is initiated. While the steps illustrated in FIG. 5 refer to the steps performed by the search engine 250, those skilled in the art will readily recognize that other methods of searching the index table 250 can be used.

When a user/customer/client wishes to search the database to, for example, check on the status of an order, or to check an inventory total before placing an order, the user would activate the search engine 250, through a web page or other user interface. An example of a user interface is illustrated at FIG. 6.

The user first enters a query text into the user interface 600 of line 601. The text may be entered into the search engine by typing or speaking the desired text. However, other methods of entering the text can also be used. As user are familiar with Internet based searches, the textual input entered into search engine 250 can be a common phrase. For example, if the user wants to find all of the “light companies” that are customers of the company, then the textual input entered by the user could be “customer light” or it could be “who are light customers.” The entry of the search query through button 602 is illustrated at block 502 of FIG. 5.

Next, search engine 250 takes the query 262, and breaks it into individual words. In our example “customer light” is broken into “customer” and “light”. In the other example; “who are the light customers” is broken into “who”, “are”, “the”, “light” and “customers”. This is illustrated at block 504 of FIG. 5. Optionally the search engine 250 can remove common stop words from the query at block 506. Stop words are words that contribute little to the meaning or aboutness of the query, and typically include words such as “is”, “are”, “the”, “a”, “an”, “how”, “who”, “what”, etc. Once the stop words are removed, a more efficient targeted search of the index table 240 can be performed. Therefore, in the second example the query 262 is reduced to “light”, “customer” and “company”.

Once the query 262 is parsed to is component parts, the search engine 250 searches the index table 240 to find matches to the query 262. The search engine 250 moves between each record in the index table 240 and determines if there is a match to at least one word in the query 262. The search engine 250 can search the index table 240 one word at a time, or can search for all of the words in the query 262. However, other methods of identifying the words in the index table 240 can be used.

As each record in the index table 240 is analyzed by the search engine 250, a score is assigned to the record based upon the number of words in the record that matched the query 262. In one embodiment, if no words are present the record is assigned a score of 0, if one word is present the record is assigned 1 point for each occurrence of the word, and if two or more words are present in the record each occurrence of the word is assigned 100 points.

When searching the index table 240 the search engine 250 can identify both words in the field or label metadata fields as well as the actual data. In the example above using the query “customer light”, the search engine 250 can identify a record having a field <customer> and data “light company” as a match. This searching of the index table 240 and scoring is illustrated at blocks 510 and block 512 of FIG. 5.

During the initial query entry step at block 502 the user, in an alternative embodiment, can select the specific fields to search on in the user interface 600. This allows the user to more accurately direct the search to the relevant information. The selection of the fields to search van be searched from a pull down menu 603 with spinner keys 604 or a series of check boxes (not illustrated). Of course other methods can be used. When the fields of the search are limited, additional search logic may be added to the query 262 to limit the number of results yielding high scores. This additional logic is illustrated at block 503.

Following the searching of the index table 240 and the scoring of the matches, the results are ranked. This ranking of results is illustrated at block 514. In one embodiment, the results having the highest scores are ranked the highest. However, other methods of ranking can be used, such as results having the query words closest together.

Once the results are ranked the search engine 250 prepares to display the results to the user. However, in order to protect the integrity of the information in the database 230/240 the search engine 250 checks the permissions associated with each matched entry in the index table 240 with the user's permissions. If the user's permissions do not allow access to a particular record, then that record is removed from the results. This removal of records is illustrated at block 518 of FIG. 5. Alternatively, the search engine 250 can block out only that portion of the record the user is not permitted to view.

After verifying that the results can be presented to the user, the remaining results or edited results are presented to the user. This is illustrated at block 520 of FIG. 5. In one embodiment, the results are displayed on user interface 600. The results can include a hypertext link to the specific record. Contained in the results 264 is the information about the record in the index table. Depending on the configuration of the search engine 250 and user interface 260, each result 264 may be displayed as a text line result, may be displayed as a table, or any other way of displaying results on the user interface 260. An example of the displayed results is illustrated at 605 in FIG. 6.

The user then reviews the results, and can select one of the results to view more details. This process is illustrated at block 522 of FIG. 5. In one embodiment, the user clicks on the hyperlink representing the desired record to view. An example of the link is illustrated at 606 in FIG. 6. The search engine 250 then accesses the record in the business data database 230 corresponding to the selected record. The record is then displayed to the user through the user interface device 260 in a predetermined manner. This is illustrated at block 514. Of course if portions of the record contain information or fields the user is not allowed to view, the search engine 250 will exclude that record from the display. Alternatively, the user may be provided only with the information contained in the index table 240. However, this may not give the user the most current data for the record, depending on when the record was last indexed by the crawler 210.

In conclusion the present invention allows for real time searching of a business data database without placing an undue load on any programs operating on the backend systems. The present invention achieves this result by using a crawler to crawl through the database and index records in a separate file. This separate file is later searched by a search engine thus removing the search engine process from the affecting the performance of other programs on the backend system.

Although the present invention has been described with reference to particular embodiments, workers skilled in the art will recognize that changes may be made in form and detail without departing from the spirit and scope of the invention.

1. A method for intermittently accessing and retrieving data contained in a business data database, comprising the steps of:
A) receiving an indication to begin accessing records in the business data database;
B) reading an entry in the business data database that includes business data;
C) indexing at least a portion of the business data in an index;
D) advancing to a next entry in the business data database; and
E) repeating steps B-D.

2. The method of claim 1 further comprising the step of:
pausing for a predetermined period of time prior to advancing to the next entry in the business data database.

3. The method of claim 2 further comprising the steps of:
receiving an indication from a user indicating a desired rate of pause between finishing accessing a first entry and advancing to the next entry in the business data database; and
setting the period of time to pause between entries based upon the indicated rate.

4. The method of claim 3 further comprising the steps of:
detecting a current load on the business data database; and
adjusting the rate of advance through the business data database based on the detected load.

5. The method of claim 4 further comprising the steps of:
decreasing the rate of advance if the current load is above a first threshold level; and
returning to the indicated rate when the load drops below the first threshold level.

6. The method of claim 4 further comprising the steps of:
increasing the rate of advance through the business data database if the current load is below a second threshold level; and
returning to the indicated rate when the load exceeds the second threshold level.

7. The method of claim 1 further comprising, creating a key in the index for the entry in the business data database, wherein the key corresponds to an identifier for the entry in the business data database.

8. The method of claim 7 wherein the step of indexing copies the at least a portion of the entry in the business data database to the key in the index.

9. The method of claim 8 wherein the step of indexing copies to the key a time stamp indicating a date the entry was last modified in the business data database.

10. The method of claim 1 further comprising, upon reaching a last entry in the business data database, returning to the first entry in the business data database and repeating steps B-D.

11. The method of claim 10 further comprising the step of:
marking in the index a time stamp indicating when the first entry in the business data database was accessed.

12. The method of claim 11 further comprising the step of:
marking in the index a second time stamp indicating when the first entry in the business data database was accessed for a second time.

13. The method of claim 12 when the business data database is accessed for a third or subsequent time, further comprising the steps of:
replacing the first time stamp in the indexes with the time stamp contained in the second time stamp; and
marking in the second time stamp a time stamp indicating when the first entry in the business data database was accessed for a third or subsequent time.

14. The method of claim 12 further comprising the steps of:
prior to indexing the entry, comparing the time stamp of the entry with the first time stamp;
if the time stamp of the entry is earlier than the first time stamp, then performing step D;
if the time stamp of the entry is later than the first time stamp, then performing step C.

15. The method of claim 1 further comprising the steps of:
receiving an indication form a user indicating the portions of the entry to be copied to the index; and
indexing that portion of each entry to the index.

16. The method of claim 15 further wherein indexing comprises:
replacing the entry in the index with the business data in the business data database.

17. The method of claim 1 further comprising the steps of:
receiving an indication from a user to stop accessing entries in the business data database; and
stopping the accessing of entries in response to the received stop indication.

18. The method of claim 1 further comprising the steps of:
receiving an indication from a user to display the progress of the method; and
displaying to the user the progress of the method through the business data database.

19. A computer readable medium containing computer executable instructions that, when executed, cause a computer to perform the steps of:
receiving an indication to start accessing records in a business data database that includes business data having a plurality of fields;
presenting to a user an interface, wherein the user provides an indication of a portion of the plurality of fields to be indexed for each of the entries in the business data database;
indexing the indicated portion of the plurality of fields for a first entry in the business data database;
pausing for a predetermined period of time;
advancing to a next entry in the business data database;
indexing the indicated portion of the next entry in the business data database; and
repeating instructions E and F.

20. The computer readable medium of claim 19 further comprising instructions to perform the steps of:
receiving an indication from the user indicating a desired rate of pause between finishing accessing a current entry and advancing to the next entry in the business data database; and
setting the period of time to pause between entries based upon the indicated rate.

21. The computer readable medium of claim 20 further comprising instructions to perform the steps of:
detecting a current load on the business data database; and
adjusting the rate of advance through the business data database based on the detected load.

22. The computer readable medium of claim 21 further comprising instructions to perform the steps of:
decreasing the rate of advance if the current load is above a first threshold level; and
returning to the indicated rate when the load drops below the first threshold level.

23. The computer readable medium of claim 21 further comprising instructions to perform the steps of:
increasing the rate of advance through the business data database if the current load is below a second threshold level; and
returning to the indicated rate when the load exceeds the second threshold level.

24. The computer readable medium of claim 19 wherein upon reaching a last entry in the business data database, further comprising instructions to perform the steps of:
returning to the first entry in the business data database and repeating steps B-G.

25. The computer readable medium of claim 19 further comprising instructions to perform the steps of:
marking in the index a time stamp indicating when the first entry in the business data database was accessed.

26. The computer readable medium of claim 25 further comprising instructions to perform the steps of:
marking in the index a second time stamp indicating when the first entry in the business data database was accessed for a second time.

27. The computer readable medium of claim 26 wherein when the business data database is accessed for a third or subsequent time, further comprising instructions to perform the steps of:
replacing the first time stamp in the indexes with the time stamp contained in the second time stamp; and
marking in the second time stamp a time stamp indicating when the first entry in the business data database was accessed for a third or subsequent time.

28. The computer readable medium of claim 27 further comprising instructions to perform the steps of:
prior to indexing a current entry, comparing a time stamp for the entry with the first time stamp;
if the time stamp of the entry is earlier than the first time stamp, then performing step D;
if the time stamp of the entry is later than the first time stamp, then performing step C.

29. A free text search system for use in a business data database, comprising:
a crawler component configured to intermittently access and index data stored in a plurality of records in the business data database;
a speed control module configured to control a rate of access of the records by the crawler component;
a user interface component configured to provide access to the crawler component and the speed control module;
an index table storing data received from the crawler component;
a search engine component configured to search the index table in response to a user query.

30. The free text search system of claim 29 wherein the index table comprises a plurality of data fields.

31. The free text search system of claim 30 wherein the plurality of data fields includes a field indicating a start time of a crawl.

32. The free text search system of claim 30 wherein the data received from the crawler is stored as a text string in one of the plurality of fields.

33. The free text search system of claim 29 wherein the user interface includes a selection component to select fields in the business data database to index.

34. The free text search system of claim 33 wherein the user interface includes a selection component to select a pause rate between accessing two of the plurality of records.

35. The free text search system of claim 34 wherein the user interface comprises a plurality of predetermined pause rate modes that are selectable by the user.

36. The free text search system of claim 34 wherein the user interface comprises an input area where the user can input a specific pause rate.

37. The free text search system of claim 29 wherein the user interface further comprises an area for the user to enter a search query.

38. The free text search system of claim 37 wherein the user interface further comprises an area for the user to select specific fields of the business data database to search.

39. The free text search system of claim 37 wherein the user interface further comprises a display area to display results of a search.

40. The free text search system of claim 29 wherein the speed control module further comprises:
a monitoring component to monitor a load on the business data database; and
wherein the speed control module adjusts the pause rate of the crawler in response the monitored load on the business data database.

41. The free text search system of claim 40 wherein the speed control module increases the pause rate if the monitored load exceeds a first threshold load.

42. The free text search system of claim 41 wherein the speed control module increases the pause rate if the monitored load is less than a second threshold load.
